(19) United States
(12) Patent Application Publication
(10) Pub. No.: US 2007/0231509 A1
(43) Pub. Date: Oct. 4, 2007

(54) INK-JET PRINTABLE TRANSFER PAPERS HAVING A CATIONIC LAYER UNDERNEATH THE IMAGE LAYER

(75) Inventors: Zhong Xu, Holden, MA (US); Stephen Xipeng Liu, East Providence, RI (US)

Correspondence Address: BARLOW, JOSEPHS & HOLMES, LTD., 101 DYER STREET, 5TH FLOOR, PROVIDENCE, RI, 02903, US

(73) Assignee: Arkwright, Inc., Fiskeville, RI (US)

(21) Appl. No.: 11/695,776

(22) Filed: Apr. 3, 2007

Related U.S. Application Data
(60) Provisional application No. 60/744,172, filed on Apr. 3, 2006.

(51) Int. Cl. B41M 5/00

(52) U.S. Cl. 428/32.12

(57) ABSTRACT

The invention relates to an ink-jet printable transfer paper for transferring an image from a ink-jet printable paper to a fabric surface, such as a cotton T-shirt. The invention improves the image after washing of the T-shirt having the transferred image with the transfer paper comprising a support paper having a surface coated with a first layer comprising a cationic polymer and a second ink-receptive layer comprising at lease an organic polymeric particles and a film-forming binder.

### CROSS-REFERENCE TO RELATED APPLICATION

This application claims the benefit under 34 USC 119(e) to U.S. Provisional Patent Application Ser. No. 60/744,172, filed Apr. 3, 2006.

### BACKGROUND OF THE INVENTION

1. Field of the Invention

The present invention relates to ink-jet transfer papers that can be printed with images using ink-jet printers. The printed image can be heat-transferred to fabric materials.

2. Brief Description of the Related Art

Consumers' interest in T-shirts, sweatshirts, and the like having customized images (photos, messages, illustrations, etc.) continues to grow in the United States and elsewhere. Today, consumers use personal computers and desktop printers to create images on a variety of fabric materials. Generally, the process involves generating a computerized image and sending it to an ink-jet printer that prints the image onto an ink-jet transfer paper. Commercially available ink-jet transfer papers typically comprise a support (release) paper having a surface coated with a “hot-melt” layer and “ink-receptive” imaging layer that overlays the “hot-melt” layer.

Various methods can be used to transfer the image to the fabric. In one instance, a person places the imaged paper over the fabric so that the image faces down. Then, the person irons the back surface of the paper with a hand iron. After completely transferring the image onto the fabric, the person removes the support paper after it has cooled or while it is still hot. The surface of the support paper may be first coated with silicone so that a person can easily peel the paper off after it has cooled. Ink-jet transfer papers having a silicone coating are commonly referred to as “cold-peel” papers. Ink-jet transfer papers that do not possess a silicone or other non-stick coating are commonly referred to as “hot-peel” papers, since they are peeled-off the fabric while the paper is still hot.

Hare et al., U.S. Pat. No. 6,087,061 discloses a method for applying an image to a fabric. The patent discloses that one embodiment relates to cold peel. The transfer sheet may comprise a support having a first and second surface, wherein silicone is provided on the first surface beneath a coating capable of receiving an image. The coating may be imaged with an ink-jet printer, thermal wax ribbon printer, or copier. The coating is then peeled from the transfer sheet. The peeled coating is positioned on a fabric, and a silicone sheet is then positioned on the peeled coating. The silicone sheet is hand-ironed to drive the coating into the fabric.

Kronzer, U.S. Pat. No. 5,798,179 discloses ink-jet printable heat-transfer papers for applying computer-generated graphics onto clothing. The patent discloses that the transfer paper has cold release properties and is coated with multiple layers comprising thermoplastic polymers and film-forming binders. The patent discloses that one layer may include thermoplastic polymer particles selected from the group consisting of polyolefins, polyesters, polyamides, and ethylene-vinyl acetate copolymers. The layer may also include a film-forming binder. The patent discloses suitable binders as including polyacrylates, polyethylene, and ethylene-vinyl acetates. Table IV of the patent describes a layer containing polyamide particles (ORGASOL) and a heat-sealable polyurethane (SANCOR 12676).

Kronzer, U.S. Pat. No. 5,501,902, incorporated herein by reference, discloses ink-jet printable heat-transfer materials having a first layer (e.g., film or paper), and a second layer overlaying the first layer. The second layer comprises a film-forming binder such as a polyacrylate, polyethylene, or ethylene-vinyl acetate copolymer, and particles of a thermoplastic polymer having dimensions of less than 50 micrometers. The patent discloses that the powdered thermoplastic polymer is desirably selected from the group consisting of polyolefins, polyesters, and ethylene-vinyl acetate copolymers. Further, the second layer may comprise a cationic polymer (e.g., an amide-epichlorohydrin polymer), a humectant (e.g., ethylene glycol or polyethylene glycol), ink-viscosity modifier (e.g., polyethylene glycol), a weak acid (e.g., citric acid), and/or a surfactant.

Today, most ink-jet transfer papers are designed for use with light-colored fabrics, e.g., white T-shirts.

Published PCT International Application WO 98/30749 discloses an ink-jet transfer system for applying graphic presentations, patterns, images, or typing onto light-colored clothing articles. The ink-jet transfer system comprises a carrier material (e.g., a silicone-coated or non-coated paper), a hot-melt layer overlaying the carrier material, and an ink-receiving layer overlaying the hot-melt layer. The hot-melt layer is wax-like and may comprise a dispersion of an ethylene/acrylic acid copolymer. The ink-receiving layer comprises a binder (preferably a soluble polyamide) and a highly porous pigment (preferably a polyamide pigment).

For dark-colored fabrics, e.g., black T-shirts, a white background must be created on the fabric so that the transferred image may be seen.

Published PCT International Application WO 00/73570 A1 discloses an ink-jet transfer system for dark textile substrates. The ink-jet transfer system comprises a carrier material (e.g., a silicone-coated or non-coated paper), an adhesive layer overlaying the carrier material, a white background layer overlaying the adhesive layer, and an ink-receiving layer overlaying the white background layer. The adhesive layer is preferably a hot-melt layer comprising a dispersion of an ethylene/acrylic acid copolymer or polyurethane dispersion. Polyester particles having a granular size of less than 30 μm are dispersed in the adhesive layer. The white background layer comprises permanent elastic plastics that do not melt at temperatures typically used for ironing (up to about 220° C.). Preferred elastic plastics are selected from the group consisting of polyurethanes, polyacrylates, polyalkylenes, or natural rubber. White pigments (e.g., BaSO₄, ZnS, TiO₂, or SbO) are dispersed in the white background layer. The ink-receiving layer comprises a binder and a highly porous pigment (preferably a polyamide pigment). The patent discloses the following compounds as suitable binders in the ink-receiving layer: polyacrylate, styrol/butadiene copolymers, nylon, nitrile rubber, PVC, PVAC and ethylene/acrylate copolymers. The patent discloses that a polyamide binder is preferably used.

Yuan, U.S. Pat. No. 6,667,093 discloses another ink-jet printable transfer papers for use with light or dark fabric materials. The ink-jet printable transfer paper comprises a support paper having a surface coated with a hot-melt layer comprising a thermoplastic polymer having a melting point in the range of 60.degree. to 180.degree. C., a substantially opaque layer (a) comprising a polyurethane binder and inorganic white pigment, and ink-receptive layer (b) comprising a polyurethane binder and organic polymeric particles.

Some commercially-available ink-jet transfer papers, e.g., the papers described in the above-mentioned Published PCT International Application WO 00/73570 A1 and U.S. Pat. No. 6,667,093, incorporated herein by reference, can provide images having satisfactory color quality on dark-colored fabrics. However, consumers are demanding transfer papers that will provide images having improved wash-durability and color quality. Wash-durability is a particular problem with many conventional ink-jet transfer papers. With such papers, after repeated washings and dryings of the fabric, the transferred image may have ink bleeding, develop cracks and colors may fade. In view of such problems, an ink-jet transfer paper capable of providing images having improved color quality and wash-durability on fabrics is desirable. The present invention provides such an ink-jet transfer paper.

### SUMMARY OF THE INVENTION

The present invention relates to an ink-jet printable transfer paper, comprising a support paper having a surface coated with layer (a) and ink-receptive layer (b). Layer (a) comprises at least a cationic polymer, and layer (b) comprises at least an organic polymeric particles and a film-forming binder. In one embodiment, the support paper is first coated with a silicone layer. In another embodiment, a hot-melt second layer comprising a thermoplastic polymer is coated over the silicone layer.

In one embodiment the cationic polymer containing layer (a) has a softening point in the range of 500 to 190° C. and the cationic polymer in layer (a) may be water-insoluble. In another embodiment the cationic polymer is a cationic polyurethane.

Both layer (a) and layer (b) may optionally contain inorganic pigments. Suitable inorganic pigments include silica, alumina, titanium dioxide, zinc sulfide, zinc oxide, antimony oxide, barium sulfate, and calcium carbonate. Preferably, titanium dioxide pigment is used. Suitable organic polymeric particles include polyamides, polyolefins, ploy(ethylene-co-acrylic acid) (EAA), poly(ethylene-co-vinyl acetate) (EVA), polyurethane and polyesters. Preferably, the organic polymeric particles are polyamide particles having a particle size in the range of 5 μm to 50 μm.

Typically, the total weight of layers (a) and (b) is in the range of 10 to 100 grams per square meter, and the total thickness of the support paper is in the range of about 1 mils to about 10 mils.

Suitable thermoplastic polymers for the hot-melt layer include polyamides, polyolefins, polyesters, poly(vinyl chloride), poly(vinyl acetate), polyacrylates, acrylic acid, methacrylic acid, and copolymers and mixtures thereof. Preferably, an ethylene/acrylic acid copolymer is used.

Also, the present invention encompasses methods for applying an image to a fabric material using the above-described ink-jet printable transfer paper. One method comprises the steps of: 1) printing an image on the coated layers with an ink-jet printer, 2) placing the imaged coating layers on a fabric material with the imaged side facing the fabric, and 3) ironing the protective paper, whereby the image is transferred to the fabric.

Another method comprises the steps of: 1) printing an image on the coated layers with an ink-jet printer, 2) removing the support paper from the imaged coating layers, 3) placing the imaged coating layers on a fabric material, 4) placing a protective paper (e.g., a silicone-coated transparent paper) over the imaged coating layers on the fabric material, and 5) ironing the protective paper, whereby the image is transferred to the fabric.

The ink-jet printable transfer papers are particularly suitable for producing images on fabrics such as T-shirts.

### BRIEF DESCRIPTION OF THE DRAWING FIGURES

In the drawings, which illustrate the best mode currently contemplated for carrying out the invention:

FIG. 1 is an illustration of an application method in accordance with the teachings of the present invention;

FIG. 2 is an illustration of a second application method in accordance with the teachings of the present invention; and

FIGS. 3-5 are graphical illustrations of the measured optical density of a red image on different examples and comparative examples after 5 washes.

### DETAILED DESCRIPTION OF THE INVENTION

The present invention relates to ink-jet printable transfer papers comprising a support paper having a surface coated with at least two layers (a) and (b). Layer (a) comprises at least a cationic polymer, and layer (b) comprises at least an organic polymeric particles and a film-forming binder.

The ink-jet transfer papers of this invention can be made using any suitable support paper (substrate). Examples of suitable support papers include plain papers, clay-coated papers, and resin-coated papers such as polyethylene-coated papers and latex-impregnated papers. The thickness of the support paper may vary, but it is typically in the range of about 1 mil (51 μm) to about 10 mils (254 μm). The support paper has a front surface and a back surface. A design, product trademark, company logo, or the like may be printed on the back surface. The front surface, i.e., imaging surface, of the support paper is coated with layers as described below.

Layer (a) comprises at least a cationic polymer, and layer (b) comprises at least an organic polymeric particles and a film-forming binder. In one embodiment, the support paper is first coated with a silicone layer. In another embodiment, a hot-melt second layer comprising a thermoplastic polymer is coated over the silicone layer. In another embodiment layer (a) and layer (b) both contain a cationic polymer and both may be water-insoluble cationic polymers.

Preferably, the cationic layer (a) has a softening point in the range of 50° to 190° C. and the cationic polymer in layer (a) may be water-insoluble.

Generally, layer (a) comprises about 1 to about 100 percent by weight of cationic polymer. In one embodiment the cationic polymer is cationic polyurethane. The chemistry nature of other components in layer (a) may not be important as long as they allow a softening point of layer (a) in the range of 50° to 190° C. Layer (a) may contain up to 100 percent cationic polymer or may contain other polymers or compatible components.

Representative cationic components are available as cationic polyurethanes available under the trade name of Witcobond W-215 and W-213, cationic polyacrylates available under the trade name of Truedot DPX8535-73 and EspriJET 3826, polymers having quaternary ammonium groups, for example, quaternary ammonium salt of polyethylene imine, polydiallyamine or an alkylamine polymer, polydimethylaminoethyl-methacrylate quaternary salts, polystyrene quaternary ammonium salts, polydiallydimethyl ammonium salts and polypyridine.

In the case of transfer sheet for dark and colored fabrics, layer (a) is a substantially opaque layer comprising at least a cationic polymer and an inorganic pigment. Layer (a) may also contain other durable polymer resins that allow a softening point in the range of 50° C. to 190° C. Preferably, the cationic polymer is water-insoluble. The other durable polymer resins may contain polyurethane having a softening point in the range of 120° C. to 190° C. and inorganic white pigment. More preferably, the cationic polymer is a cationic polyurethane polymer. Examples of suitable white pigments include silica, alumina, titanium dioxide, zinc sulfide, zinc oxide, antimony oxide, barium sulfate, calcium carbonate, and the like.

Layer (b) is an ink-receptive layer comprising at least an organic polymeric particles and a film-forming binder. The ink-receptive layer is capable of absorbing aqueous-based inks from an ink-jet printer to form an image. Most inks used in ink-jet printing devices are aqueous-based inks containing molecular dyes or pigmented colorants. Water is the major component in aqueous-based inks. Small amounts of water-miscible solvents such as glycols and glycol ethers may also be present.

Preferably, the ink-receptive layer (b) has a softening point in the range of 500 to 190° C. Preferably, the ink-receptive layer contains at least a mordant, which may be a cationic polymer, inorganic metal complex, cationic silica, alumina or a salt, etc.

Suitable organic polymeric particles include, for example, polyolefin, polyamide, and polyester particles. Preferably, substantially porous thermoplastic particles having a high surface area are used. These particles are better able to absorb water and water-miscible solvents contained in aqueous-based inks. For example, the particles may have a particle size distribution containing particles with a diameter size in the range of 2 μm to 100 μm and a surface area in the range of 1 m²/g to 40 m²/g. A particularly preferred polymeric particulate material is ORGASOL (polyamide particles) available from Elf Atochem North America, Inc.

Generally, ink-receptive layer (b) comprises about 10 to about 90 percent by weight binder and preferably 10 to 40 weight % binder on weight of the layer. In addition, ink-receptive layer (b) generally comprises about 90 to about 10 percent by weight organic particles and preferably 60 to 90 weight % organic particles based on weight of the layer.

Ink-receptive layer (b) is coated over layer (a) on the support paper. However, in some instances, one or more intermediate layers may be located between the support, layer (b) and layer (a). Also, it may be desirable to coat the support paper with one or more primer coatings before applying layers (a) and (b).

For example, the front surface of the support paper is preferably coated with a stick-resistant composition such as silicone, and layers (a) and (b) are coated over the stick-resistant coating layer. Although a stick-resistant coating is not required, it allows a person to peel away the support paper from layers (a) and (b) more easily as described in further detail below.

In another preferred embodiment, a “hot-melt” layer is coated over the stick-resistant coating, and layers (a) and (b) are coated over the hot-melt coating layer. The hot-melt layer may serve many functions. For example, the hot-melt layer may act as an adhesive-like layer preventing delaminating of the coating layers from the support paper. In addition, as described further below, the image is heat-transferred to the fabric using an ordinary hand iron. The hot-melt layer and image are heat-transferred to the fabric by means of pressing the hot-melt layer into the fabric with the hot iron. The hot-melt layer helps the transferred image adhere to the fabric. Preferably, the hot-melt layer comprises a thermoplastic polymer. Suitable thermoplastic polymers include, for example, polyamides, polyolefins, polyesters, poly(vinyl chloride), poly(vinyl acetate), polyacrylates, polystyrene, acrylic acid, methacrylic acid, and copolymers and mixtures thereof. Preferably, the thermoplastic polymer has a melting point in the range of 60° C. to 180° C. More preferably, an ethylene/acrylic acid, ethylene/methacrylic acid, or ethylene/vinyl acetate copolymer is used. For example, ENOREX VN 379 (an aqueous dispersion containing polymers and copolymers of acrylic acid, ethylene, methyl methacrylate, and 2-ethyl hexylacrylate, and ammonia), available from Collano Ebnöther AG, can be used. MICHEM 4983 RHS (an ethylene/acrylate copolymer), available from Michelman, Inc., can also be used. Also, polyurethane compositions can be used to form the hot-melt layer.

As shown in the following examples, the ink-jet transfer papers of this invention can be used to provide images having good print-quality, color-fastness, and wash-durability on fabric materials. It is believed that the finished fabric has such properties partly because of the compatibility and synergy of layers (a) and (b). This interfacial interaction between layer (a) and (b) may be enhanced when the medium is heated during application of the image to the fabric.

It is recognized that any of the foregoing coating layers may contain additives such as surface active agents that control the wetting or flow behavior of the coating solutions, antistatic agents, suspending agents, antifoam agents, acidic compounds to control pH, optical brighteners, UV blockers/stabilizers, processing aids to control fluid rheology and the like.

Conventional coating techniques can be used to apply the layers to the support paper. For example, roller, blade, wire bar, dip, solution-extrusion, air-knife, and gravure coating techniques can be used. Typically, the total weight of the coating layers is in the range of 10 to 100 grams per square meter (gsm). The coating layers may be dried in a conventional oven.

The ink-jet transfer papers of this invention can be printed with an image using any conventional ink-jet printer. For example, ink-jet printers made by Océ, Hewlett-Packard, Epson, Encad, Canon, and others can be used.

The printed image can be transferred to the fabric material by various methods. Any colored fabrics may be used including white fabrics. The ink-jet transfer papers of this invention are suitable for transferring images to light or dark-colored fabrics.

Preferably, the image is heat-transferred to the fabric using an ordinary household iron. One preferred method, for light fabric, involves the following steps:
a) placing the imaged coatings (film-like material) on the fabric so that the image faces-down (i.e., the image is not exposed; it is face-down against the fabric);
b) hand-ironing the back side of the transfer sheet so that the imaged coatings are pressed into the fabric and the image is transferred to the fabric; and
c) removing the backing paper.

Another preferred method, for dark or colored fabric, involves the following steps:
d) peeling the support paper from the imaged coatings so that the imaged coatings remain as a film-like material;
e) placing the imaged coatings (film-like material) on the fabric so that the image faces-up (i.e., the image is exposed; it is not face-down against the fabric);
f) placing a sheet of protective paper over the image;
g) hand-ironing the protective paper so that the imaged coatings are pressed into the fabric and the image is transferred to the fabric; and
h) removing the protective paper.

The sheet of protective paper used in step (f) is preferably a stick-resistant transparent paper, e.g., a silicone-coated tissue paper. A person can easily remove such papers from the fabric after the ironing step. The support paper that is peeled away from the imaged coatings in step (d) should not be used again as the protective paper in step (f). It is not recommended that the peeled-off support paper be used, because, among other deficiencies, it may curl up along its edges during the ironing step. Rather, the protective paper should be a fresh sheet. Transparent sheets of paper offer several advantages. Particularly, if a transparent sheet is used, the person ironing the sheet can better observe the image as it transfers to the fabric, and he or she can avoid under or over-heating the fabric. If too little heat is applied, the image does not completely transfer and the image may peel away from the fabric. If too much heat is applied, burn marks may appear on the image and fabric.

The present invention is further illustrated by the following examples using the below-described test methods, but these examples should not be construed as limiting the scope of the invention.

### Test Methods

### Print-Quality

The ink-jet transfer papers were printed with multicolor test patterns using several different desktop ink-jet printers and printing modes as described in Table A below. Then, the printed ink-jet transfer papers were visually inspected to determine print quality. The print quality of images having significant inter-color bleeding was considered poor. The print quality of images having little or no inter-color bleeding was considered good.

TABLE A

| Ink-Jet Printers | Printing Paper Mode |
|---|---|
| Epson Stylus R200 | Matte Heavy Weight Paper |
| HP Deskjet 5550 | Auto/Normal |

### Optical Density

The media samples of Examples 3, 4, 5, 6 and 7 and Comparative Examples C, D and E were imaged (printed) with a multicolored test pattern. The printed samples were stored at room temperature for 24 hours. Subsequently, the optical density of red ink for each sample was measured with a X-Rite 408 Reflection Densitometer (available from X-Rite, Inc.) using standard procedures described in the instrument manual provided by the manufacturer. Generally, media having higher optical density values provide images of higher quality and resolution. The optical density of the red print image was initially measured and also measured after each wash for 5 washes.

### Ironing

A printed image was heat-transferred to 100% cotton T-shirts using the above-described preferred method. The hand iron was set at “maximum cotton” and heated. The hot iron was applied to the backside of the transfer sheet or the silicone-coated protective paper using moderate pressure for about two (2) to three (3) minutes. After cooling for about three (3) to five (5) minutes, the backing sheet or the silicone-coated protective paper was peeled away from the T-shirt.

### Color-Fastness and Wash-Durability

After about twenty-four (24) hours, the above-described ironed T-shirts were washed and dried under the following conditions:

### Kenmore 70 Series Heavy Duty Washer

### Speed (Agitate/Spin)—Delicate (slow/slow)

### Water Temp. (Wash/Rinse)—Cold/Cold

### Water Level—Small to medium load

### Washing—Ultra clean 10 cycle

### Kenmore Heavy Duty Dryer

### Setting—Knit/Delicate

The above washing and drying cycle was repeated five (5) to twenty (20) times for examples 1 and 2 and Comparative Examples A and B. The above washing and drying cycle was repeated five (5) times for Examples 3, 4, 5, 6 and 7 and Comparative Examples C, D and E. For examples 1 and 2 and for Comparative Examples A and B, the printed T-shirts were then visually inspected to determine ink-bleed and color-fastness of the image (poor, fair, or good). Images having significant ink-bleed or color fading were considered to have poor color-fastness, while images having little or no color fading were considered to have good color-fastness. For Examples 3, 4, 5, 6 and 7 and Comparative Examples C, D and E, the optical density of the red printed image was evaluated. Images having a retained higher optical density after washing are considered to have better color-fastness and less fading during normal and repeated washes.

### EXAMPLES

In the following examples, percentages are by weight based on the weight of the coating formulation, unless otherwise indicated.

### Example 1

### The following coating formulations were prepared.

| | Weight % |
|---|---|
| Hot Melt Layer | |
| Michem 4983RHS¹ | 98% |
| BYK 348² | 2% |
| White Layer | |
| Witcobond W-213³ | 90% |
| Ti-pure RPDV⁴ | 10% |
| Ink-Receptive Layer | |
| Witcobond W-213³ | 18% |
| ORGASOL⁵ | 22% |
| WATER | 16% |
| ETHANOL | 43% |

¹Polyethylene copolymers dispersion, available from Michelman Inc.
²Surfactant, available from BYK-Chemie USA.
³Cationic Polyurethane dispersion, available from Chemchura.
⁴Titanium dioxide pigment, available from Dupont.
⁵Polyamide resin particles, available from Elf Atochem North America, Inc.

### Comparative Example A

### The following coating formulations were prepared.

| | Weight % |
|---|---|
| Hot Melt Layer | |
| Michem 4983RHS¹ | 98% |
| BYK 348² | 2% |
| Layer (a) | |
| SANCURE 12929⁶ | 84% |
| TINT AYD NV7003⁷ | 15.4% |
| BYK 348² | 0.6% |
| Ink-Receptive Layer (b) | |
| Witcobond W-213³ | 18% |
| ORGASOL⁵ | 22% |
| WATER | 16% |
| ETHANOL | 43% |

¹Polyethylene copolymers dispersion, available from Michelman Inc.
²Surfactant, available from BYK-Chemie USA.
³Cationic Polyurethane dispersion, available from Chemchura.
⁵Polyamide resin particles, available from Elf Atochem North America, Inc.
⁶Polyurethane dispersion, available from Noveon, Inc.
⁷Titanium dioxide pigment, available from Daniel Products, New Jersey

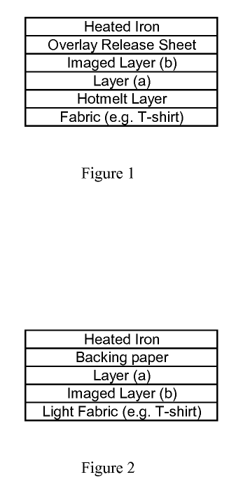

FIG. 1 shows the application method for Example 1 and Comparative Example A.

In the above examples, the hot melt formulation was first applied to a silicone-coated support paper using a Meyer metering rod and dried in an oven at 100° C. for about 3 minutes. The layer (a) coating formulation was applied over the hot-melt layer using a Meyer metering rod and dried in an oven at 100° C. for about 3 minutes. Finally, the image layer (b) coating formulation was applied over the layer (a) using a Meyer metering rod and dried in an oven at 100° C. for about 3 minutes. Per the Test Methods described above, images (prints) were produced on the ink-jet transfer papers, and the imaged T-shirts were evaluated for print-quality, color-fastness. The results are reported below in Table I.

TABLE I¹

| Sample | Print-Quality | 1^{st}-wash bleed | 5^{th}-wash color |
|---|---|---|---|
| Example 1 | Good | Good | Good |
| Comp. Example A | Good | Poor | Good |

¹Image printed with a Epson Stylus R200 printer in Matte Heavy weight paper mode.

### Example 2

### The following coating formulations were prepared.

| Layer (a) | |
|---|---|
| Witcobond W-213¹ | 100% |
| Ink-Receptive Layer (b) | |
| Elvamide 8023² | 6% |
| ORGASOL³ | 18% |
| WATER | 22% |
| ETHANOL | 37% |

¹Cationic Polyurethane dispersion, available from Chemchura.
²Polyamide, available from Dupont
³Polyamide resin particles, available from Elf Atochem North America, Inc.

### Comparative Example B

### The following coating formulations were prepared.

| | Weight % |
|---|---|
| Layer (a) | |
| Permax 200¹ | 98% |
| BYK 348² | 2% |
| Ink-Receptive Layer | |
| Elvamide 8023⁴ | 6% |
| ORGASOL³ | 18% |
| WATER | 22% |
| ETHANOL | 37% |

¹Nonionic polyurethane dispersion, available from Neveon, Inc.
²Surfactant, available from BYK-Chemie USA.
³Polyamide resin particles, available from Elf Atochem North America, Inc.
⁴Polyamide, available from Dupont

FIG. 2 shows the application method for Example 2 and Comparative Example B. In the above examples, the layer (a) coating formulation was applied using a Meyer metering rod and dried in an oven at 100° C. for about 3 minutes. Finally, the image layer (b) coating formulation was applied over the layer (a) using a Meyer metering rod and dried in an oven at 100° C. for about 3 minutes. Per the Test Methods described above, images (prints) were produced on the ink-jet transfer papers, and the imaged T-shirts were evaluated for print-quality, color-fastness. The results are reported below in Table II.

TABLE II¹

| Sample | Print-Quality | 1^{st}-wash bleed | 20^{th}-wash color |
|---|---|---|---|
| Example 2 | Good | Good | Good |
| Comp. Example B | Good | Fair | Poor |

¹Image printed with a HP Desk-jet 5550 printer in auto/normal mode.

### Examples 3 to 5 and Comparative Example C

Examples 3 to 5 and Comparative Examples C demonstrate the improvement according to the invention from employing various types of cationic ionic polymer in the non-ink receptive coating of the image transfer sheet. FIG. 2 shows the application method to the cotton T-shirts.

### Example 3

### The following coating formulations were prepared.

| Layer (a) | |
|---|---|
| Witcobond W-213¹ | 90% |
| Isopropyl Alchol | 10% |
| Ink-Receptive Layer (b) | |
| Elvamide 8023² | 7.2% |
| ORGASOL³ | 16.8% |
| WATER | 28.1% |
| ETHANOL | 47.9% |

¹Cationic Polyurethane dispersion, available from Chemchura.
²Polyamide, available from Dupont
³Polyamide resin particles, available from Elf Atochem North America, Inc.

### Example 4

### The following coating formulations were prepared.

| Layer (a) | |
|---|---|
| Permax 200¹ | 80.2% |
| Syntran HX31-65² | 9.8% |
| Isopropyl alcohol | 10.0% |
| Ink-Receptive Layer (b) | |
| Elvamide 8023³ | 7.2% |
| ORGASOL⁴ | 16.8% |
| WATER | 28.1% |
| ETHANOL | 47.9% |

¹Cationic Polyurethane dispersion, available from Chemchura.
²Cationic acrylate copolymer, available from Interpolymer Corp., Canton, MA.
³Polyamide, available from Dupont
⁴Polyamide resin particles, available from Elf Atochem North America, I

### Example 5

### The following coating formulations were prepared.

| Layer (a) | |
|---|---|
| Permax 200¹ | 87.9% |
| Glascol F207² | 12.1% |
| Ink-Receptive Layer (b) | |
| Elvamide 8023³ | 7.2% |
| ORGASOL⁴ | 16.8% |
| WATER | 28.1% |
| ETHANOL | 47.9% |

¹Cationic Polyurethane dispersion, available from Chemchura.
²Cationic polymer, available from Ciba Specialty Chemicals.
³Polyamide, available from Dupont
⁴Polyamide resin particles, available from Elf Atochem North America, Inc.

### Comparative Example C

### The following coating formulations were prepared.

| Layer (a) | |
|---|---|
| Permax 200¹ | 90.0% |
| Isopropyl Alcohol | 10.0% |
| Ink-Receptive Layer (b) | |
| Elvamide 8023² | 7.2% |
| ORGASOL³ | 16.8% |
| WATER | 28.1% |
| ETHANOL | 47.9% |

¹Nonionic polyurethane dispersion, available from Neveon, Inc.
²Polyamide, available from Dupont
³Polyamide resin particles, available from Elf Atochem North America, Inc.

### Discussion of Examples 3, 4, 5 and Comparative Example C

Examples 3, 4, 5 and Comparative Ex. C were prepared with layer (a) coating formulation being applied using a Meyer metering rod and dried in an oven at 100° C. for about 3 minutes. Finally, the image layer (b) coating formulation was applied over the layer (a) using a Meyer metering rod and dried in an oven at 100° C. for about 3 minutes. Per the Test Methods described above, images (prints) were produced on the ink-jet transfer papers, and the imaged T-shirts were evaluated for print-quality, color-fastness. The results are reported below in Table III.

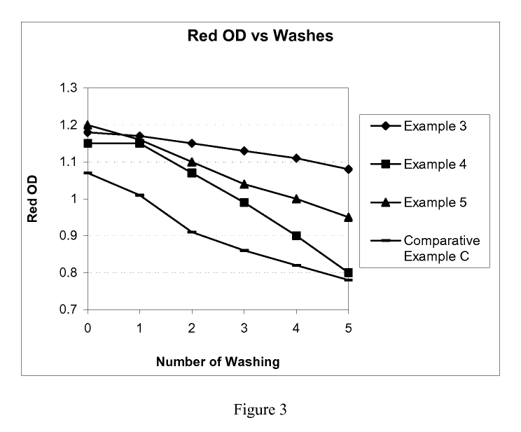

Examples 3 to 5 were prepared according to the invention and comparative example C was prepared for comparison without the cationic polymer in layer (a). The samples were evaluated by washing for five (5) washes and the optical density of the red printed image was measured after each wash. The printing ands washes were conducted as described for Examples 1 and 2. The optical density measurements for the red image after 5 wash and drying cycles are set forth in Table II and graphically depicted in FIG. 3. As shown in FIG. 3, the use of a cationic polymer in the layer below the ink receptive layer provides for a higher optical density throughout the five (5) washing cycles. For example, after five cycles the optical density between example 3 and comparative example C is over 0.2 and is readily visible to an observer of the two imaged samples.

TABLE III
Red OD¹

| EX. | Wash 0 | Wash 1 | Wash 2 | Wash 3 | Wash 4 | Wash 5 |
|---|---|---|---|---|---|---|
| 3 | 1.18 | 1.17 | 1.15 | 1.13 | 1.11 | 1.08 |
| 4 | 1.15 | 1.15 | 1.07 | 0.99 | 0.90 | 0.80 |
| 5 | 1.20 | 1.16 | 1.10 | 1.04 | 1.00 | 0.95 |
| C | 1.07 | 1.01 | 0.91 | 0.86 | 0.82 | 0.78 |

¹Optical Density of Red Image. HP DeskJet 5550 in Normal Mode.

### Example 6 and Comparative Example D

### Example 6

### The following coating formulations were prepared.

| | |
|---|---|
| Witcobond W-213¹ | 90% |
| Isopropyl Alcohol | 10% |
| Ink-Receptive Layer (b) | |
| Elvamide 8023² | 7.0% |
| ORGASOL³ | 16.4% |
| WATER | 27.4% |
| ETHANOL | 46.7% |
| Witcobond W-213³ | 2.4% |

¹Cationic Polyurethane dispersion, available from Chemchura.
²Polyamide, available from Dupont
³Polyamide resin particles, available from Elf Atochem North America, Inc.

### Comparative Example D

The following coating formulations were prepared:

| Layer (a) | |
|---|---|
| Permax 200¹ | 100% |
| Ink-Receptive Layer (b) | |
| Elvamide 8023² | 7.0% |
| ORGASOL³ | 16.4% |
| WATER | 27.4% |
| ETHANOL | 46.7% |
| Witcobond W-213⁴ | 2.4% |

¹Nonionic polyurethane dispersion, available from Neveon, Inc.
²Polyamide, available from Dupont
³Polyamide resin particles, available from Elf Atochem North America, Inc.
⁴Cationic Polyurethane dispersion, available from Chemchura.

### Discussion of Example 6 and Comparative Example D:

Example 6 and Comparative Example D were prepared with layer (a) coating formulation being applied using a Meyer metering rod and dried in an oven at 100° C. for about 3 minutes. Finally, the image layer (b) coating formulation was applied over the layer (a) using a Meyer metering rod and dried in an oven at 100° C. for about 3 minutes. Per the Test Methods described above, images (prints) were produced on the ink-jet transfer papers, and the imaged T-shirts were evaluated for print-quality, color-fastness. The results are reported below in Table IV.

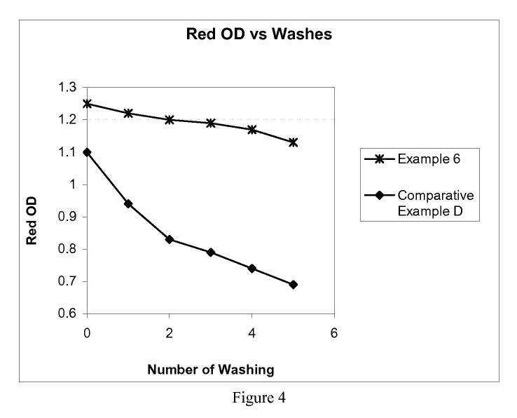

Example 6 was prepared according to the invention with a cationic polymer in layer (a) and in layer (b) and Comparative example D was prepared for comparison with a cationic polymer in layer (b) but without a cationic polymer in layer (a). FIG. 2 shows the method of application to the cotton T-shirts. The samples were evaluated by washing for five (5) washes and the optical density of the red printed image was measured after each wash. The printing ands washes were conducted as described for Examples 1 and 2. The optical density measurements for the red image after 5 wash and drying cycles are set forth in Table IV and graphically depicted in FIG. 4. As shown in FIG. 4, the use of a cationic polymer in layer (a) and layer (b) the ink receptive layer provides for a higher optical density throughout the five (5) washing cycles than use of the same cationic polymer in layer (b). For example, after five cycles the optical density between example 6 and comparative example D is over 0.4 and is readily visible to an observer of the two imaged samples.

TABLE IV
Red OD¹

| EX. | Wash 0 | Wash 1 | Wash 2 | Wash 3 | Wash 4 | Wash 5 |
|---|---|---|---|---|---|---|
| 6 | 1.25 | 1.22 | 1.20 | 1.19 | 1.17 | 1.13 |
| D | 1.10 | 0.94 | 0.83 | 0.79 | 0.74 | 0.69 |

¹Optical Density of Red Image. HP DeskJet 5550 in Normal Mode.

### Example 7 and Comparative Example E

### Example 7

### The following coating formulations were prepared.

| Layer (a) | |
|---|---|
| Witcobond W-213¹ | 90% |
| Isoproyl Alcohol | 10% |
| Ink-Receptive Layer (b) | |
| Elvamide 8023² | 6.9% |
| ORGASOL³ | 16.1% |
| WATER | 27.0% |
| ETHANOL | 45.9% |
| Syntran HX31-65⁴ | 4.1% |

¹Cationic Polyurethane dispersion, available from Chemchura.
²Polyamide, available from Dupont
³Polyamide resin particles, available from Elf Atochem North America, Inc.
⁴Cationic acrylate copolymer, available from Interpolymer Corp., Canton, MA.

### Comparative Example E

### The following coating formulations were prepared.

| Layer (a) | |
|---|---|
| Permax 200¹ | 100% |
| Ink-Receptive Layer (b) | |
| Elvamide 8023² | 6.9% |
| ORGASOL³ | 16.1% |
| WATER | 27.0% |
| ETHANOL | 45.9% |
| Syntran HX31-65⁴ | 4.1% |

¹Nonionic polyurethane dispersion, available from Neveon, Inc.
²Polyamide, available from Dupont
³Polyamide resin particles, available from Elf Atochem North America, Inc.
⁴Cationic acrylate copolymer, available from Interpolymer Corp., Canton, MA.

### Discussion of Example 7 and Comparative Example E:

Example 7 and Comparative Ex. E were prepared with layer (a) coating formulation being applied using a Meyer metering rod and dried in an oven at 100° C. for about 3 minutes. Finally, the image layer (b) coating formulation was applied over the layer (a) using a Meyer metering rod and dried in an oven at 100° C. for about 3 minutes. Per the Test Methods described above, images (prints) were produced on the ink-jet transfer papers, and the imaged T-shirts were evaluated for print-quality, color-fastness. The results are reported below in Table V.

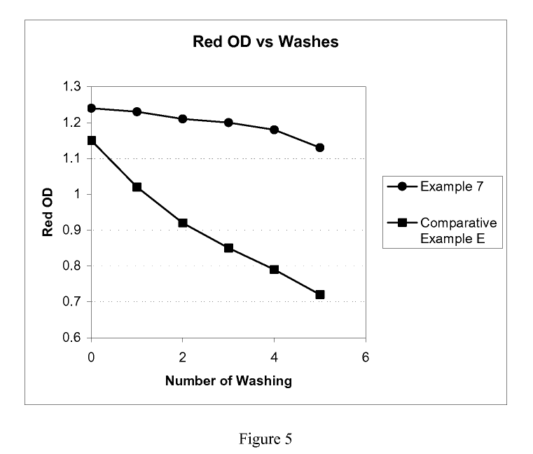

Example 7 was prepared according to the invention using one cationic polymer in layer (a) and a different cationic polymer in layer (b). Comparative example E was prepared for comparison without any cationic polymer in layer (a) or layer (b). FIG. 2 shows the method of application to the cotton t-shirts. The samples were evaluated by washing for five (5) washes and the optical density of the red printed image was measured after each wash. The printing ands washes were conducted as described for Examples 1 and 2. The optical density measurements for the red image after five (5) wash and drying cycles are set forth in Table V and graphically depicted in FIG. 5. As shown in FIG. 5, the use of a cationic polymer in the layer (a) provides for a higher optical density throughout the five (5) washing cycles. For example, after five cycles the optical density between example 7 and comparative example E is over 0.4 and is readily visible to an observer of the imaged samples.

TABLE V
Red OD¹

| EX. | Wash 0 | Wash 1 | Wash 2 | Wash 3 | Wash 4 | Wash 5 |
|---|---|---|---|---|---|---|
| 7 | 1.24 | 1.23 | 1.21 | 1.20 | 1.18 | 1.13 |
| E | 1.15 | 1.02 | 0.92 | 0.85 | 0.79 | 0.72 |

¹Optical Density of Red Image. HP DeskJet 5550 in Normal Mode.

What is claimed is:

1. An ink-jet printable transfer paper, comprising a support paper having a surface coated with layer (a) comprising at least a cationic polymer, and layer (b) comprising at least organic polymeric particles and a film-forming binder.

2. An ink-jet printable transfer paper according to claim 1 wherein layer (a) contains a white pigment.

3. An ink-jet printable transfer paper for transferring an image to a fabric material, comprising a support paper having a surface coated with: a hot-melt layer comprising a thermoplastic polymer having a melting point in the range of 60 degree to 180 degree C., a substantially opaque layer (a) comprising at least one cationic polymer and inorganic white pigment, and ink-receptive layer (b) comprising a film forming binder and organic polymeric particles.

4. The ink-jet printable transfer paper of claim 1, wherein the film forming binder comprising layer (b) has a softening point in the range of 50 degree C. to 190 degree C.

5. The ink-jet printable transfer paper of claim 1, wherein the inorganic pigment comprising layer (a) is selected from the group consisting of silica, alumina, titanium dioxide, zinc sulfide, zinc oxide, antimony oxide, barium sulfate, and calcium carbonate.

6. The ink-jet printable transfer paper of claim 3, wherein the pigment is titanium dioxide.

7. The ink-jet printable transfer paper of claim 1, wherein the film forming binder comprising layer (b) has a softening point in the range of 50 degree to 190 degree C.

8. The ink-jet printable transfer paper of claim 5, wherein the film forming binder comprising layer (b) contains cationic groups.

9. The ink-jet printable transfer paper of claim 1 wherein the organic polymeric particles comprising layer (b) are selected from the group consisting of polyamides, polyolefins, and polyesters.

10. The ink-jet printable transfer paper of claim 7, wherein the thermoplastic polymeric particles are polyamide particles having a particle size in the range of 5 μm to 50 μm and a surface area in the range of 1 m²/g to 40 m²/g.

11. The ink-jet printable transfer paper of claim 1, wherein the total weight of layers (a) and (b) is in the range of 25 to 100 grams per square meter.

12. The ink-jet printable transfer paper of claim 1, wherein the thickness of the support paper is in the range of about 1 mils to about 10 mils.

13. An ink-jet printable transfer paper for transferring an image to a fabric material, comprising a support paper having a surface coated with: a) a first layer comprising silicone, b) a hot-melt second layer comprising a thermoplastic polymer having a melting point in the range of 60 degree to 180 degree C., said second layer overlaying the first layer, c) a substantially opaque third layer comprising a cationic polyurethane polymer and inorganic white pigment, said third layer overlaying said second layer, and d) an ink-receptive fourth layer comprising a polyurethane binder and organic polymeric particles, said fourth layer overlaying said third layer.

14. The ink-jet printable transfer paper of claim 13, wherein the fourth layer comprises a thermoplastic polymer selected from the group consisting of polyamides, polyolefins, polyesters, poly(vinyl chloride), poly(vinyl acetate), polyacrylates, acrylic acid, methacrylic acid, and copolymers and mixtures thereof.

15. The ink-jet printable transfer paper of claim 12, wherein the layer (b) comprises ethylene/acrylic acid copolymer.

16. The ink-jet printable transfer paper of claim 1 wherein layer (a) and layer (b) each contain a water-insoluble cationic polymer.

17. The Ink-jet transfer paper of claim 14 wherein the cationic water-insoluble cationic polymer is a cationic polyurethane.

18. The inik-jet transfer paper of claim 14 where in the cationic polymer is selected from the group consisting of polymers having quaternary ammonium groups.

19. The ink-jet transfer paper of claim 1 wherein the cationic polymer is selected from the group comprising cationic polyurethanes, cationic polyacrylates quaternary ammonium salt of polyethylene imine, polydiallyamine or an alkylamine polymer, polydimethylaminoethyl-methacrylate quaternary salts, polystyrene quaternary ammonium salts, polydiallydimethyl ammonium salts and polypyridine.

20. The ink-jet transfer paper of claim 3 wherein the cationic polymer is selected from the group comprising cationic polyurethanes, cationic polyacrylates, quaternary ammonium salt of polyethylene imine, polydiallyamine or an alkylamine polymer, polydimethylaminoethyl-methacrylate quaternary salts, polystyrene quaternary ammonium salts, polydiallydimethyl ammonium salts and polypyridine.

21. The ink-jet transfer paper of claim 14 where in amount of cationic polymer in layer (a) is greater than layer (b).

22. A method for applying an image to a fabric material, comprising the steps of: a) providing an ink-jet printable transfer paper, comprising a support paper having a surface coated with: a hot-melt layer comprising a thermoplastic polymer having a melting point in the range of 60 degree to 180 degree. C.; layer (a) comprising a cationic polymer; and ink-receptive layer (b) comprising a film forming polymer binder and organic polymeric particles, b) printing an image on the coated layers with an ink-jet printer, c) placing the imaged coated layers on a fabric material and d) ironing the support paper, whereby the image is transferred to the fabric.

23. The method of claim 22, wherein the support paper is a transparent silicone-coated paper.

24. A method for applying an image to a fabric material, comprising the steps of: a) providing an ink-jet printable transfer paper, comprisinga support paper, layer (a) comprising a cationic polymer coated on the support paper; and ink-receptive layer (b) comprising a film forming polymer binder and organic polymeric particles coated on layer (a); printing an image on the coated layer (b) with an ink-jet printer, c) placing the imaged coated layers on a fabric material and d) ironing the support paper, whereby the image is transferred to the fabric.

25. The method according to claim 24 wherein layer (a) and layer (b) each contain a water-insoluble cationic polymer.

26. The method according to claim 25 wherein the water-insoluble cationic polymer is water insoluble cationic polyurethane.
